(19) United States
(12) Patent Application Publication
(10) Pub. No.: US 2025/0007795 A1
(43) Pub. Date: Jan. 2, 2025

(54) Processes for monitoring, verification and configuration, and entities configured to implement these processes

(71) Applicant: ORANGE, ISSY LES MOULINEAUX (FR)

(72) Inventors: Mohamed Boucadair, Chatillon (FR); Christian Jacquenet, Chatillon (FR)

(21) Appl. No.: 18/708,788

(22) PCT Filed: Nov. 8, 2022
(86) PCT No.: PCT/EP2022/081047

§ 371 Date: May 9, 2024

(30) Foreign Application Priority Data
Nov. 10, 2021 (FR) FR2111973

(51) Int. Cl. H04L 41/5054; H04L 41/0813

(52) U.S. Cl. CPC H04L 41/5054; H04L 41/0813

(57) ABSTRACT

A method for controlling a check carried out on data conveyed in a network when a first device of a user accesses a service provided by a second device via a primary connection. The method is implemented by a control entity and includes: triggering, with a coordinating entity, a configuration of the service such that data conveyed on the primary connection and on at least one secondary connection established on the fringes of the primary connection for the provision of the service pass through a checking entity selected by the control entity to analyze the data; and notifying the coordinating entity if an event is detected in a digital identity of the user conveyed when accessing the service and including identification information in relation to the user obtained from the data analyzed by the checking entity.

### PRIOR ART

The invention belongs to the general field of telecommunications.

It relates more particularly to the management of sensitive data conveyed on a communication network (for example an Internet Protocol (IP) network) when a first device, such as a client equipment (for example a terminal of a user or a CPE (customer premises equipment)), accesses a service provided by a second device, such as a server or a service platform.

The sensitive data that are the focus of the invention are more specifically information that contributes to identifying an individual, referred to here as “identification information”, as defined in particular in section 5.2.2 of document RFC 6973 published by the IETF and entitled “Privacy Considerations for Internet Protocols”, July 2013. Such identification information may be linked to a particular individual and may be used, on its own or in combination with other elements, to infer or recognize the identity of this individual. Said information may be of diverse and varying nature; it may in particular involve identifiers, strictly speaking, of the user or of the equipment used thereby, but also other data such as their location or the location of neighbors of an equipment (for example a terminal) of this user, logs of the user on one or more websites, particular message fields characteristic of communication protocols, etc. Indeed, many types of information are able to provide indications about the identity of the user, on their own or in combination with other information.

As document RFC 6973 emphasizes, in some contexts, it is perfectly legitimate to identify individuals (for example Distributed Denial of Service (DDoS) attackers). However, in other contexts, such identification may be problematic, for example because it prevents the individual from benefiting from the anonymity necessary for their activity or an operation in which they are participating, or because it discloses elements that could jeopardize the privacy of the individual or that of other individuals, or else because it gives the opportunity to exercise control over the individual in question or differential treatment, etc.

Nowadays, the mass use of communication means, the proliferation of software applications installed on users' terminals (for example smartphones, laptops, tablets) and the sophistication of the underlying technological building blocks is leading to an ever greater collection of data that may be shared with various platforms, such as service platforms or other infrastructures called upon when accessing services (for example advertising or web tracking platform), and this is generally unbeknownst to users. Hereinafter, these data that are thus collected and shared are referred to generally as “telemetry data”.

The collection of telemetry data is not limited to data useful for the correct operation of an application or service, but may also comprise identification information that discloses sensitive elements in relation to users' privacy. Similarly, it is not limited to certain applications, but also concerns the majority of operating systems (or OS) installed on users' terminals. For example, the operating systems installed on mobile terminals send the following telemetry data to infrastructures managed by the providers of the operating systems in question: IMEI (International Mobile Equipment Identity) identifier, serial number, serial number of the SIM (Subscriber Identity Module) card, public telephone number, local IP address, MAC (Medium Access Control) address of the terminal, MAC addresses of nearby available terminals, along with other unique identifiers. However, these practices are not specific to mobile terminals.

Telemetry data reported by the one or more operating systems of a terminal, in correlation with access data to certain services, may make it possible to recognize the identity of the user of the terminal, or even disclose information that jeopardizes their privacy or that of other individuals who do not even use said services.

For example, collecting MAC addresses of terminals close to the terminal of a user makes it possible to build, over time, a kind of network that gives indications about social relationships, areas of interest and other sensitive and characteristic information in relation to the user.

Indeed, the telemetry data reported by a given terminal may be used to track other terminals, even if they do not support a given operating system. By way of illustration, let us assume a terminal H, connected to a local area network, and having an operating system OS #1 configured to inform for example an infrastructure OSCloud, located in the cloud, of the presence of a terminal vH neighboring the terminal H and supporting another operating system OS #2. The terminal H may thus reveal the MAC address (Mac@1) of vH, transmit data in relation to its location, etc. When the terminal vH connects to another network, the terminals connected to this other network and equipped with the same operating system OS #1 in turn inform the infrastructure OSCloud of the presence of the terminal vH and its MAC address (@mac1), transmit data in relation to its location, etc. The terminal vH may then be identified easily by the infrastructure OSCloud by correlating all of the information received: MAC addresses and/or any other telemetry data reported by the terminals equipped with the operating system OS #1.

A priori, the vast majority of users do not have means to detect (and prevent) the sending of such telemetry data and avoid sharing them with external entities. It should be noted that activating the “private” mode offered by some applications (such as some Web browsers, for example) does not prevent telemetry data from being sent by these applications.

It is possible to envisage implementing certification and auditing mechanisms to check the telemetry data collected by a service infrastructure and to ensure that the telemetry data thus collected are needed to provide this service. These mechanisms may be implemented in particular by what are known as authoritative servers with which the terminals of the users of the service establish connections in order to access the service, retrieve a content item, etc. Such mechanisms aim, on the one hand, to ensure that the telemetry data that are collected are compatible with the general terms and conditions of use of the service and, on the other hand, to check that they do not violate the legislative/regulatory provisions in force (for example the General Data Protection Regulation or GDPR in the European Union). These mechanisms may be implemented at the request of the service provider, a local regulatory authority, or any other body.

However, locally auditing the one or more authoritative servers of a service infrastructure is not sufficient to draw conclusions regarding compliance with the provisions covered by the audit. Indeed, a service may involve a complex infrastructure, also called a service realm, which is not limited to authoritative servers. This complex infrastructure may involve in particular front-end servers, load balancers, servers terminating secure connections (for example TLS (Transport Layer Security) connections), data retention servers (or logging servers), content distribution servers, etc. In addition, the provision of the service may be distributed and involve for example an anycast cluster, cache servers, etc. Some service providers also offer a DNS (domain name system) service, a tracking service, etc.

Multiple servers may therefore be called upon to provide one and the same service, including when this service is “simple” access to a website. A connection established to an authoritative server as part of a service, referred to here as “primary connection”, is therefore more often than not supplemented with a set of sub-connections to other servers, referred to here as “secondary connections”: in other words, access to a service is the result of combining a plurality of connections including the primary connection and one or more secondary connections. Each of these secondary connections may itself give rise to the establishment of other connections. The information collected by all of the servers with which these various connections have been established may be correlated and used for purposes of profiling, identifying or tracking users, etc. Auditing the one or more authoritative servers of a service is therefore insufficient to assess compliance with the confidentiality clauses of a service.

### SUMMARY OF THE INVENTION

The invention proposes a solution that makes it possible to carry out a check on the telemetry data conveyed on a network while taking into account the complexity of the service infrastructures.

More particularly, the invention relates, according to a first aspect, to a method for controlling a check carried out on data conveyed in at least one communication network when a first device of a user accesses a service provided by a second device via what is referred to as a primary connection established between the first and the second device, this method being intended to be implemented by a control entity and comprising:
a step of triggering, with a coordinating entity, a configuration of the service such that data conveyed on the primary connection and on at least one secondary connection established on the fringes of (that is to say in addition to) this primary connection for the provision of the service pass through at least one checking entity selected by the control entity to analyze these data; and
a step of notifying the coordinating entity, if a determined event is detected in a digital identity of the user conveyed when accessing the service and comprising identification information in relation to the user obtained from the data analyzed by said at least one checking entity.

In correlation, the invention also targets a control entity for controlling a check carried out on data conveyed in at least one communication network when a first device of a user accesses a service provided by a second device via what is referred to as a primary connection established between the first and the second device, this control entity comprising:
a trigger module, configured to trigger, with a coordinating entity, a configuration of the service such that data carried on the primary connection and on at least one secondary connection established on the fringes of this primary connection for the provision of the service pass through at least one checking entity selected by the control entity to analyze these data; and
a notification module, configured to notify the coordinating entity, if a determined event is detected in a digital identity of the user conveyed when accessing the service and comprising identification information in relation to the user obtained from the data analyzed by said at least one checking entity.

For example, the coordinating entity is hosted by the infrastructure offering the service. It controls the elements involved in the provision of the service, and is thus able to configure the service, upon command of the control entity, such that all or some of the data conveyed on the primary and secondary connections passes through one or more checking entities selected by the control entity to analyze these data and determine in particular whether they contain identification information in relation to the user. Such identification information, when detected by the one or more checking entities initiated by the control entity, are recorded by said one or more checking entities in a digital identity of the user associated with the service (which reflects the digital identity of the user held by the service). It should be noted, as emphasized above with reference to document RFC 6973, that the concept of identification information within the meaning of the invention does not just include information that, on its own, unambiguously identifies the user. This concept also encompasses other information that (for example due to the order in which it appears in the messages transmitted by the client equipment of the user) induces details about the identity of the user or that, in mutual correlation or in correlation with other elements, makes it possible to obtain such details. Such identification information consists for example of the identification of an access network to which the client equipment of the user is connected, the location of the client equipment of the user, a MAC address of a neighboring client equipment, etc. The digital identity supplied by the one or more checking entities may comprise not just the identification information extracted directly from the data analyzed by said one or more checking entities, but also the details provided by this identification information or obtained by correlating this identification information (possibly with other elements), which, as such, also constitutes identification information within the meaning of the invention.

Depending on the content of the digital identity collected by the checking entities, the control entity may need to notify the coordinating entity. For example, such a notification may be triggered upon detection of at least one event by what is referred to as a checking entity from among:
a new data collection platform involved in accessing said service;
a level of exposure of identification information in relation to the user above a given threshold;
new user identification information detected by said at least one checking entity in said analyzed data;
user identification information transmitted to a third-party entity that does not comply with terms and conditions of use of said service approved by said user.

The invention therefore proposes a collaborative solution based on a control entity controlling one or more checking entities located on paths taken by the data of the primary connection and by those of the secondary connections established on the fringes of this primary connection, and on a coordinating entity, able to configure the service such that the data conveyed when accessing the service pass through the checking entities in question in order to be analyzed. The digital identity supplied by the checking entities based on the data that they analyze from the identification information in relation to the user makes it possible to correlate the results of the analyses carried out by each of the checking entities, where applicable, and to detect any breaches regarding this identification information when providing the service, which breaches may be detrimental to the user (for example disclosure of sensitive information). The coordinating entity is then informed of this, and is able to quickly take measures to rectify these breaches and/or inform the user thereof (by adapting their general terms and conditions of use, for example).

For example, the correlation made possible by the invention through the construction of the digital identity of the user may reveal practices such as delegating subdomains to third parties through traffic redirection (technique referred to as CNAME (Canonical NAME) cloaking). This practice allows third parties to place “cookies” on the user's device, which are considered to be “first-party” cookies (that is to say for saving for example preferences or an identifier (“login”) of the user when accessing a site), thereby making it possible to avoid possible blockages put in place by browsers. Such a practice opens the door to a significant security breach, since it allows, de facto, third parties to access authentication tokens stored in the cookies.

The invention therefore offers the possibility of dynamically (that is to say on request) carrying out a global audit (that is to say a check) on the service in order to identify sensitive information relating to a user and shared between the various infrastructures involved in or called upon when invoking the service and to characterize how this sensitive information is processed. The global audit proposed by the invention is therefore an audit the results of which will enable a user of the service to better protect their privacy (which may also be referred to as a “privacy protection audit” for the sake of simplification). The invention is not limited to auditing the authoritative server involved in the provision of the service (“on-site audit”), but also makes it possible to initiate off-site audits, making it possible to have a global view of the user's identification information that is conveyed and shared when the service is invoked. The invention makes it possible in particular to detect undue exposure of this sensitive information, such as exposure that does not conform with general terms and conditions of use accepted by the user and/or with regulatory provisions.

The invention may advantageously be coupled with an on-site audit mechanism that, for its part, makes it possible to evaluate certain practices such as data storage, scripts such as data extraction algorithms activated on the authoritative server etc., so as to make the conclusions of the audit conducted by virtue of the invention more reliable.

In one particular embodiment, the triggering step is conditional upon prior acceptance of the coordinating entity to carry out the analysis of said data.

This prior acceptance may take various forms, such as for example checking that the control entity is authorized to trigger such analysis in accordance with a static audit agreement concluded beforehand between the service provider and the audit service provider (that is to say the entity that manages the control entity and the checking entities), or a dynamic exchange put in place between the coordinating entity and the control entity using the CPNP protocol (Connectivity Provisioning Negotiation Protocol) defined in document RFC 8921 published by the IETF in October 2020, etc. This prior agreement or dynamic exchange makes it possible to define the scope of the privacy protection audit carried out by the control entity and the checking entities, and in particular the data flows to be analyzed (for example all flows, regardless of their origin or one or more specific categories of flows), the one or more users involved, the connections to be audited (random or targeted selection, resulting from an explicit request from an administrator or executed based on external events, such as for example the change of general rules of use), etc.

In one particular embodiment, the control method comprises a step of selecting said at least one checking entity on the basis of at least one service constraint that is predetermined or transmitted by the coordinating entity.

Such a constraint is for example a maximum authorized detour time, a geographical area, an autonomous system (or AS) number, etc. This advantageously makes it possible to ensure that the audit or checking process is transparent to the user or at the very least to minimize its impact on the quality of experience as perceived by the user.

In one particular embodiment, the triggering step of the control method comprises providing said coordinating entity with reachability information in relation to said at least one checking entity.

Such reachability information is for example an IP address or a domain name corresponding to said at least one checking entity. It allows the coordinating entity to program the service function chain so as to include the one or more checking entities in the path of the data that are intended to be analyzed by said one or more checking entities. To this end, various solutions may be envisaged: modifying the domain name resolution (DNS) chain such that the reachability information in relation to the one or more checking entities is communicated to the first device, activating a service function chaining (or SFC) mechanism such that the one or more checking entities are invoked in the paths taken by the data intended to be analyzed by said one or more checking entities, redirecting the data intended to be analyzed to the one or more checking entities, etc.

As is apparent from the above, the invention relies on the control entity, but also on the one or more checking entities selected by the control entity to process the data.

Thus, according to a second aspect, the invention also targets a method, carried out by a checking entity, for processing data conveyed on at least one communication network when a first device of a user accesses a service provided by a second device via what is referred to as a primary connection established between the first and the second device, at least one what is referred to as secondary connection being established on the fringes of said primary connection when providing said service, said method comprising:
a step of receiving data conveyed via said primary connection and/or at least one said secondary connection;
if at least one item of identification information in relation to the user is obtained from said received data, on the basis of said at least one obtained item of identification information, a step of updating a digital identity of the user conveyed when accessing said service; and
a step of relaying said received data to a recipient of said data.

In correlation, the invention also relates to a checking entity for checking data conveyed on at least one communication network when a first device of a user accesses a service provided by a second device via what is referred to as a primary connection established between the first and the second device, at least one what is referred to as secondary connection being established on the fringes of said primary connection when providing said service, said checking entity comprising:
a reception module, configured to receive data conveyed via said primary connection and/or at least one said secondary connection;
an update module, activated if at least one item of identification information in relation to the user is obtained from said data, and configured to update a digital identity of the user conveyed when accessing said service on the basis of said at least one obtained item of identification information; and
a transmission module configured to relay said received data to a recipient of said data.

Thus, preferably, the digital identity is updated only if the one or more items of identification information detected, where applicable, in the data are not already contained in the digital identity collected by the checking entities and associated with said service.

The checking entity and the processing method according to the invention benefit from the same advantages mentioned above as the control entity and the control method according to the invention.

In one particular embodiment, the processing method furthermore comprises a step of analyzing the received data in order to determine whether they convey (explicitly or implicitly (in this case; analyzing the observed data makes it possible to deduce additional identification information)) at least one item of identification information in relation to the user, said analysis step using at least one parameter with which said checking entity has been configured beforehand and/or that it has acquired via executing a machine learning algorithm.

There are thus various possible options (which may be implemented as an alternative or in addition) for detecting sensitive information conveyed by the data transmitted on the primary and secondary connections. According to a first option, the checking entity may be configured beforehand with a set of determined parameters enabling it to recognize identification information among the analyzed data. Such parameters may be for example particular headers of messages to be sought, such as those used by an operating system, or specific identification information (determined in advance, such as an MSISDN (Mobile Station ISDN Number) or IMEI (International Mobile Equipment Identity) identifier, a serial number, etc.), or an ordered sequence of certain data in a data packet. According to a second option, the checking entity may acquire such parameters dynamically, via a machine learning algorithm that is able for example to detect persistent identifiers involved in an exchange linked to the service. This machine learning algorithm may be parameterized by the audit service provider, for example in compliance with the contractual information that defines its relationship with its clients (for example, a regulatory authority may initiate the audit to check compliance with the commitments made by the service provider to its clients) or by another party, such as for example the user. It should be noted that the results of the algorithm may differ depending on the nature of the parameterization and the entity that carries out this parameterization. If a party other than the audit service provider is envisaged, then a procedure is preferably implemented to safeguard this parameterization and ensure that it is actually authorized (for example sharing of a unique identifier between the party and the control entity, which communicates this identifier to the coordinating entity in order to be able to identify the party later on).

In one particular embodiment, the processing method furthermore comprises:
a step of obtaining a list of identification information declared as being conveyed when accessing said service and/or one or more processing operations applied to said list of identification information;
a step of checking the conformity of the digital identity of the user with said list and/or with said obtained processing operations; and
a reporting step in the event of non-conformity.

In other words, the checking entity is responsible for analyzing the digital identity of the user as collected in accordance with the invention when the user accesses the service, and for determining whether it conforms with what is expected (that is to say as declared by the service provider or by the providers of ancillary services invoked on the secondary connections when accessing the service).

Otherwise, the checking entity reports this to various entities according to multiple variants: this reporting may be carried out for example by sending a notification to the control entity, which is responsible for relaying it to the coordinating entity, for example, or to the user, or else to the audit service provider or to all of these entities. As a variant, the checking entity may add an indicator to the digital identity able to be accessed by the control entity or the user.

In another embodiment, it may be envisaged for this analysis to be entrusted to an entity other than a checking entity. This may be relevant in particular when multiple checking entities are made responsible by the control entity for analyzing the data conveyed when the user accesses the service. It is therefore necessary to ensure that this other entity has access to the digital identity collected by the one or more checking entities. This may be the control entity (which manages the plurality of checking entities and has access to the digital identity) or a third-party entity.

In one particular embodiment, the processing method comprises a step of reporting, to a control entity, at least one event detected by the checking entity from among:
a new data collection platform involved in accessing said service;
a level of exposure of identification information in relation to the user above a given threshold;
new user identification information detected by said at least one checking entity in said analyzed data;
user identification information transmitted to a third-party entity that does not comply with terms and conditions of use of said service approved by said user.

Of course, this list is not exhaustive. Other analyses may thus be carried out by the checking entity or the other entity (control entity or third-party entity) based on the digital identity of the user collected when accessing the service.

In one particular embodiment, the processing method comprises a step of sending, to the first device, a header comprising reachability information in relation to said at least one checking entity, said header indicating to said first device that it should send its domain name resolution requests to said at least one checking entity.

In other words, this embodiment proposes a dynamic DNS configuration of the first device, suitable for implementing the invention. Indeed, it advantageously makes it possible to ensure that the checking entity traces all secondary connections established on the fringes of the primary connection in the context of the user accessing the service.

As mentioned above, the invention also relates, according to a third aspect, to a coordinating entity and to the method implemented by this coordinating entity.

More particularly, the invention targets a method for configuring a service provided to a first device by a second device via what is referred to as a primary connection established between the first and the second device, said configuration method being intended to be implemented by a coordinating entity and comprising, upon request of a control entity, a step of configuring the service such that data conveyed on said primary connection and on at least one secondary connection established on the fringes of said primary connection for the provision of the service pass through at least one checking entity selected by said control entity to analyze said data.

In correlation, the invention also relates to a coordinating entity able to configure a service provided to a first device by a second device via what is referred to as a primary connection established between the first and the second device, said coordinating entity comprising a configuration module, activated upon request of a control entity and programmed to configure said service such that data conveyed on said primary connection and on at least one secondary connection established on the fringes of said primary connection for the provision of the service pass through at least one checking entity selected by said control entity to analyze said data.

The coordinating entity and the configuration method according to the invention benefit from the same advantages mentioned above as the control entity, the checking entity, the control method and the processing method according to the invention.

In one particular embodiment, the configuration step is preceded by a checking step that consists in checking whether said control entity is authorized to trigger analysis of said data by said at least one checking entity.

This makes it possible to ensure collaboration between the control entity and the coordinating entity for coordinating the service.

As mentioned above, in one particular embodiment, the configuration method comprises a step of transmitting, to said control entity, at least one constraint of said service to be taken into account to select said at least one checking entity.

In another embodiment, the configuration step comprises triggering:
modification of a domain name resolution mechanism so as to include reachability information in relation to said at least one checking entity; or
activation of a service function chaining mechanism involving said at least one checking entity; or
a routing mechanism at the source; or
redirection of data to said at least one checking entity.

This makes it possible to ensure that the data from the primary connection and the secondary connections pass through the one or more checking entities designated to analyze the data.

In one particular embodiment, triggering a modification of a domain name resolution mechanism comprises sending, to the first device, a header comprising said reachability information in relation to said at least one checking entity, said header indicating to said first device that it should send its domain name resolution requests to said at least one checking entity.

In one particular embodiment of the configuration method according to the invention, triggering a modification of a domain name resolution mechanism comprises, on an entity involved in the provision of the service, activating sending, to the first device, of a header comprising said reachability information in relation to said at least one checking entity, said header indicating to said first device that it should send all or some of its domain name resolution requests to said at least one checking entity.

In one particular embodiment, the control, processing and/or configuration methods are implemented by a computer.

The invention also targets a computer program on a recording medium, this program being capable of being implemented in a computer or more generally in a control entity according to the invention and comprising instructions designed to implement a control method as described above.

The invention also targets a computer program on a recording medium, this program being capable of being implemented in a computer or more generally in a checking entity according to the invention and comprising instructions designed to implement a processing method as described above.

The invention also targets a computer program on a recording medium, this program being capable of being implemented in a computer or more generally in a coordinating entity according to the invention and comprising instructions designed to implement a configuration method as described above.

Each of these programs may use any programming language, and be in the form of source code, object code, or of intermediate code between source code and object code, such as in a partially compiled form, or in any other desirable form.

The invention also targets a computer-readable information medium or recording medium including computer program instructions, such as mentioned above.

The information medium or recording medium may be any entity or device capable of storing the programs. For example, the medium may include a storage means, such as a ROM, for example a CD-ROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the invention may in particular be downloaded over the Internet.

As an alternative, the information medium or recording medium may be an integrated circuit in which a program is incorporated, the circuit being designed to execute or to be used in the execution of the management, registration and communication methods according to the invention.

According to a fourth aspect, the invention also targets a checking system comprising at least one control entity, at least one checking entity and at least one coordinating entity according to the invention.

It is also possible, in other embodiments, to envisage the control, processing and configuration methods, along with the control, checking and coordinating entities, and the checking system according to the invention having all or some of the abovementioned features in combination.

### BRIEF DESCRIPTION OF THE DRAWINGS

Other features and advantages of the present invention will emerge from the description given below, with reference to the appended drawings, which illustrate one exemplary embodiment thereof that is in no way limiting. In the figures:

FIG. 1 shows, in its environment, a checking system according to the invention, in one particular embodiment;

FIG. 2 schematically shows the hardware architecture of a computer able to host any one of the entities according to the invention belonging to the checking system of FIG. 1;

FIG. 3 shows the various steps of the control, checking and configuration methods according to the invention in one particular embodiment in which they are implemented by the entities of the checking system of FIG. 1;

FIG. 4 illustrates one example of modifying a domain name resolution chain in order to implement the invention.

### DESCRIPTION OF THE INVENTION

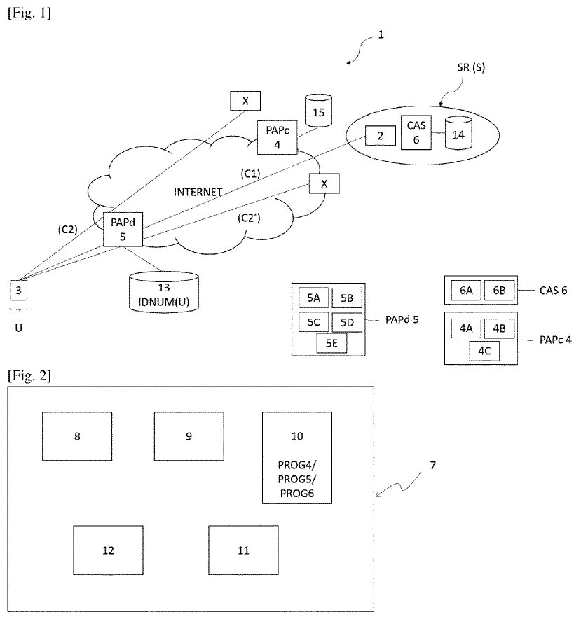

FIG. 1 shows a checking system 1 according to the invention, in one particular embodiment.

In the example envisaged in FIG. 1, the checking system 1 offers a mechanism (also referred to here as DYOS service or procedure, for dynamic off-site IP privacy assessment procedure) advantageously making it possible to carry out global checking operations (also sometimes referred to as audit operations or privacy protection audit operations in this document) of checking that a service S offered by a service provider SP via the Internet complies with protecting the privacy of its users, and in particular the confidentiality of their personal data. The check that is carried out may be generic and relate to the entire service S or, on the contrary, be more specific and relate only to a given category of flows exchanged when a user accesses this service (for example those generated by a particular application or operating system, those associated with a particular operator, etc.). Such a check may advantageously be triggered dynamically upon request, for example upon request from a user of the service S, or from the provider SP of the service S, or else from a third party.

To provide the service S, the service provider SP relies on a service infrastructure hosted in a service realm SR. For the sake of simplification, it will be considered here that the service realm SR comprises an authoritative server 2 (second device within the meaning of the invention) with which, in order to access the service S, a user U establishes what is referred to as a primary connection (C1) via at least one user equipment 3 (first device within the meaning of the invention). For the sake of simplification, in the example envisaged and described by FIG. 1, it will be considered that the user U uses a single user equipment 3 to access the service S. However, this hypothesis is not limiting per se.

As mentioned above, multiple servers, referenced by X in FIG. 1 and separate from the authoritative server 2, may also be called upon to provide the service S; these servers X are involved when accessing the service S in what are referred to as secondary connections (C2), (C2′), etc. established with the user equipment 3 on the fringes of the primary connection (C1) between the user equipment 3 and the authoritative server 2, in order to provide what are referred to as services “ancillary” to the service S (for example domain name resolution, web tracking). As a result, the connection established, strictly speaking, by the user equipment 3 on behalf of the service S is the combination of a primary connection (C1) to the authoritative server 2 and a set of secondary connections (C2), (C2′), etc. to these other servers X providing these services ancillary to the service S. It should be noted that the secondary connections are often established transparently for the user U.

To access the Internet and the service S, the user equipment 3 may be connected directly to a network of an operator (for example cellular access network or PLMN (public land mobile network) as illustrated in FIG. 1), or via a local area network (LAN) such as a home network, a corporate network, etc., via a dedicated equipment designated by CPE (customer premises equipment).

No assumption is made regarding the nature of the service S, which may also rely on a service realm SR comprising a plurality of servers (for example authoritative server, cache servers, load balancers, etc.) hosted in a single structure (for example a cloud computing infrastructure) or a single equipment, or in multiple structures or multiple equipments. Such a service S may be a service involving an operating system installed on the user equipment 3, or an application installed on the user equipment 3 (for example HTTP Web service, or Voice over IP SIP, or WebRTC), or else a service provided by a network operator, etc. The service S may also be located in a network other than the Internet, for example in a network of an operator or in a public infrastructure (for example public cloud).

Moreover, no limit is attached to the nature of the user equipment 3 used by the user U to access the service S. It may be a fixed or mobile equipment such as for example a smartphone, a laptop or desktop computer, a digital tablet, etc. It should be noted that the user U may be either a natural person or a legal person (for example a company) or else a group of individuals (for example individuals attached to the same household).

Moreover, the user equipment 3 may have a plurality of communication interfaces enabling it to access the network in which the service realm SR is located. The invention applies to both single-interface and multi-interface user equipments 3, regardless of the nature of these interfaces (for example LAN, WLAN, 3G/4G/5G). Similarly, a CPE equipment may be connected to multiple operator networks (what is referred to as a “multi-homing” context).

It will be assumed here that an operating system OS and one or more applications APP #i, i=1, . . . , N, N denoting an integer greater than or equal to 1, are installed and activated on the user equipment 3, and that at least one of them is called upon to access the service S. As mentioned above, the operating system OS and/or the one or more applications APP #i, i=1, . . . , N, may collect and share various types of what are referred to as telemetry data here with service infrastructures involved in providing the service S, whether on the primary connection established by the user equipment 3 or on the secondary connections (C2), (C2′), etc. established on the fringes of this primary connection (C1). These telemetry data comprise service data, but also identification information that may concern the user equipment 3, its home network, its IP neighbors, its default router, the operator of the network to which it is connected, etc. and that, exploited individually or in mutual correlation, may induce or reveal details about the identity of the user U.

In addition, other data (also assimilated here to telemetry data) including identification information may be injected into the data packets transmitted by the user equipment 3 by entities of the various networks through which these packets pass (for example access network) on the primary connection (C1) and secondary connections (C2), (C2′), etc., and without the user U of the user equipment 3 having necessarily consented thereto. This identification information may be added in particular at the application level, for example in HTTP headers such as the proprietary HTTP headers HTTP_MSISDN, HTTP_X_UP_CALLING_LINE_ID, HTTP_X_NOKIA_MSISDN, HTTP_X_HTS_CLID, HTTP_X_MSP_CLID, HTTP_X_NX_CLID, HTTP__RAPMIN, HTTP_X_WAP_MSISDN, HTTP_COOKIE, HTTP_X_UP_LSID, HTTP_X_H3G_MSISDN, HTTP_X_NETWORK_INFO, etc., in TCP (Transmission Control Protocol) options, in IPv4 options, in IPv6 extension headers, etc. It should be noted that some of this identification information should normally be deleted by the networks passed through, but the inventors have observed that this is not always the case in practice, and that such identification information may be shared with third-party infrastructures (for example servers X introduced above) in the same way as the identification information included in the data packets by the user equipment 3 itself (for example by its operating system OS or by the applications APP #i, i=1, . . . , N).

To audit the service S (that is to say to check that the way in which it is used respects the privacy and in particular the confidentiality of the personal data of the user U), in other words to implement the DYOS procedure proposed by the invention, the checking system 1 relies on multiple entities, namely on:
a control entity 4 or PAPc 4 (for privacy assessment point control plane), in accordance with the invention, and hosted in the DYOS service realm;
one or more checking entities 5 or PAPd 5 (for PAP data plane), in accordance with the invention; and
a coordinating entity 6 for coordinating the service S or CAS 6 (for cooperative audit server), in accordance with the invention, and hosted in the service realm SR. This coordinating entity 6 is configured in particular to interface with the control entity 4 and with the entity that requested the execution of the DYOS procedure for the service S.

It should be noted that the control entity 4 and all or some of the checking entities 5 may be collocated or, on the contrary, hosted in separate hardware or software equipments. In addition, checking entities 5 may be deployed at various locations, such as for example on the Internet, in the access network to the Internet used by the user equipment 3 to access the authoritative server 2, in the service realm SR associated with the service S, in the authoritative server 2, etc. These may be virtual (that is to say software-based) instances that are activated on demand, this activation preferably taking place using secure mechanisms (with authentication of the virtual instances) and/or integrity checking. A known mechanism such as TEEP (Trusted Execution Environment Provisioning) or RATS (Remote Attestation Procedures Architecture) may in particular be used for this purpose.

In the embodiment described here, the control entity 4, the checking entity 5 and the coordinating entity 6 have the hardware architecture of a computer 7 as shown in FIG. 2, or, when virtual instances are involved, are hosted by hardware equipments having such a hardware architecture and exploit the elements of this hardware architecture.

The computer 7 comprises in particular a processor 8, a random access memory 9, a read-only memory 10, a non-volatile memory 11, and communication means 12 enabling in particular the entities of the checking system 1 to communicate with one another and with other entities such as for example with the user equipment 3 or else with entities called upon when the user equipment 3 accesses the service S.

The read-only memory 10 of the computer 7 constitutes a recording medium in accordance with the invention, able to be read by the processor 8 and on which there is recorded a computer program in accordance with the invention.

More specifically, the read-only memory 10 of the computer 7 comprises, when said computer is or hosts a control entity 4 in accordance with the invention, a recording of a computer program PROG4 comprising instructions defining the main steps of a control method according to the invention.

This program PROG4 defines functional modules of the control entity 4 that rely on or control the abovementioned hardware elements 8 to 12 of the computer 7. These modules comprise, in particular, in the embodiment described here:
a selection module 4A for selecting at least one checking entity 5 to analyze all or some of the data conveyed when the user equipment 3 accesses the service S. The way in which this selection is carried out is described in more detail later on with reference to the steps of the control method according to the invention. It should be noted that multiple checking entities 5 may be deployed and selected by the control entity 4 to optimize the routing of the data when accessing the service S, but also the processing thereof by the checking entities. For example, it is possible to envisage activating a checking entity 5 as close as possible to the user equipment 3 and/or as close as possible to the authoritative server 2. In addition, the checking entities 5 may be generic (that is to say be configured to process any type of service) or specialize in the processing of certain services only (and telemetry data relating to these services), such as for example checking entities specializing in the processing of service data involving the operating system OS, or checking entities specializing in the processing of service data involving an application APP #i, i=1, . . . , N (for example HTTP Web services, Voice over IP SIP, WebRTC), or else checking entities specializing in the processing of service data of services offered by network operators (and telemetry data injected by access network operators), etc. Mutual authentication mechanisms, such as for example TLS (Transport Layer Security), may be implemented between the control entity 4 and the one or more checking entities 5 that it has selected to audit the data transmitted when the user U accesses the service S;
a trigger module 4B, configured to trigger, with a coordinating entity 6 for coordinating the service S, a configuration of said service such that the data conveyed on the primary connection (C1) and on at least one secondary connection (C2), (C2′), etc. established on the fringes of this primary connection for the provision of the service S pass through the one or more checking entities 5 selected by the control entity 4 so as to allow them to analyze these data; and
a notification module 4C, configured to notify the coordinating entity 6, if a determined event is detected in a digital identity IDNUM(U) of the user 3 conveyed when accessing the service S and comprising identification information in relation to the user 3 obtained from the data that the one or more checking entities 5 have analyzed. The event in question may be for example the detection of new identification information or of exposure of the identification information in relation to the user U exceeding a given threshold, or else of an indication regarding the identity of the user resulting from the correlation of multiple items of identification information stored in the digital identity IDNUM(U). It may be detected by the control entity 4 itself by examining the digital identity IDNUM(U), or be reported thereto by a checking entity 5 or else by a third-party entity that has access to the digital identity IDNUM(U) (for example in the case of a plurality of checking entities involved in the analysis of the data transmitted by the user equipment 3, as mentioned below).

The digital identity IDNUM(U) of the user U is stored here in a storage space 13 shared by the control entity 4 and by the one or more checking entities 5. It may be a digital file (for example a database) comprising all of the identification information relating to the user U and detected by the checking entities 5 on the primary and secondary connections to which it is desired to apply the DYOS procedure. This identification information may be extracted by the checking entities 5 from the telemetry data inserted into the data packets coming from the user equipment U as part of its access to the service S and conveyed on the connections analyzed by the checking entities 5, as described in more detail later on. As mentioned above, it may be any type of information likely to contribute to the identification of the user, as defined in particular in section 5.2.2 of document RFC 6973 cited above. Such identification information may be linked to a particular individual or group of individuals and may be used, on its own or in combination with other elements, to infer or recognize the identity of this individual or this group of individuals. Said information may be of diverse and varying nature; it may in particular involve identifiers, strictly speaking, of the user or of the equipment used thereby, but also other data such as their location or the location of neighbors of this user, logs of the user on one or more sites, particular message fields characteristic of the activation of communication protocols, etc. Indeed, many types of information are able to provide indications about the identity of the user, on their own or in combination with other information (for example GPS location, network taken, etc.).

It should also be noted that the digital identity IDNUM(U) may furthermore be supplied with the details about the identity of the user induced by the identification information detected in the data analyzed by the checking entities 5 and/or resulting from the mutual correlation of this identification information or its correlation with other elements. Such details constitute identification information within the meaning of the invention, which may be stored by the entity that obtains them (checking entity 5, control entity 4 or third-party entity) in the digital identity IDNUM(U) of the user U.

It should also be noted that the digital identity IDNUM(U) of a user may result from the analysis of the primary and secondary connections of multiple user equipments associated with one and the same user U and used simultaneously by said user to access the service S. Moreover, the storage space 13 may be dedicated to a single user U or, as a variant, group together the digital identities of multiple separate users, for example users connected to one and the same local area network or access network, and thus make it possible, based on these separate digital identities, to derive a digital identity of the network in question.

By way of illustration, the digital identity IDNUM(U) of the user U may comprise, for example, all or some of the following identification information:
the list of entities called upon when the user equipment 3 accesses the service S for the primary connection and the secondary connections (including the entities of the service infrastructure supporting the service S, but also other entities called upon when accessing the service, such as for example the servers X mentioned above);
the one or more locations (for example GPS (Global Positioning System)) of the user equipment 3;
the IMSI (International Mobile Subscriber Identity) identifier assigned to the user U;
the MSISDN identifier assigned to the user U;
the IMEI identifier assigned to the user U;
an identifier of the local area network to which the user equipment 3 is connected, where applicable (for example MAC address of the equipment CPE);
the identity of visitors to a network;
the one or more IP addresses allocated to the user equipment 3;
the one or more MAC addresses of the user equipment 3;
the number of the SIM card associated, where applicable, with the user equipment 3;
the one or more operators of the one or more access networks used by the user equipment 3;
any other telemetry datum inserted into the data coming from the user equipment 3 and shared with the entities involved in accessing the service, and considered to be identification information in relation to the user U.

Of course, this list is not exhaustive, and other elements may be included in the digital identity IDNUM collected by the checking entities 5. For example, as mentioned above, the digital identity IDNUM may also comprise identification information obtained from the identification information extracted by the checking entities 5 (for example induced thereby or obtained by mutually correlating it or correlating it with other elements).

The functions of the modules 4A to 4C of the control entity 4 are described in more detail below with reference to the steps of the control method according to the invention.

When the computer 7 is or hosts a checking entity 5 in accordance with the invention, the read-only memory 10 of the computer 7 comprises a recording of a computer program PROG5 comprising instructions defining the main steps of a checking method according to the invention.

This program PROG5 defines functional modules of the checking entity 5 that rely on or control the abovementioned hardware elements 8 to 12 of the computer 7. These modules comprise, in particular, in the embodiment described here:
a reception module 5A, configured to receive data conveyed via the primary connection (C1) established between the user equipment 3 and the authoritative server 2 and/or at least one said secondary connection (C2), (C2′), etc. established on the fringes of the primary connection (C1), based on the data to be analyzed entrusted to the checking entity 5;
an analysis module 5B, configured to analyze the received data in order to determine whether these data (explicitly or implicitly) convey one or more items of identification information in relation to the user U. Various configurations of the analysis module 5B may be envisaged for this purpose, as an alternative or in addition. The analysis module 5B may thus be configured beforehand by the DYOS service provider (typically in compliance with the contractual information that defines its relationship with its clients) or by a third party (for example by the user of the client equipment or by the provider of the service S) with a set of specific parameters characterizing identification information likely to be conveyed in the data exchanged when the user U accesses the service S, in other words to recognize such identification information among the analyzed data or to exploit the data enabling said identification information to be obtained. For example, such parameters may be HTTP message headers such as those used by an operating system (for example X-Apple-I-SRL-NO, X-Mme-Device-Id, X-Mme-Country, X-Apple-seid) or types of identifiers that may be included in the body of messages carrying the data (for example serial number, IMSI, IMEI, device identifier or device ID). As a variant, the analysis module 5B may be configured with parameters acquired via executing a machine learning algorithm (the execution of which may be based on the production and operation of a neural network) that makes it possible to detect the existence of persistent identifiers in an exchange linked to the service S, and providing to characterize the duration of persistence and the type of each persistent identifier thus detected. The persistent identifier types may be indicated explicitly in messages having these persistent identifiers or inferred by comparison with other known identifier types (for example MAC address), or else result from a configuration by the DYOS service provider, or by the user of the client equipment, etc. It should be noted that, regardless of the configuration chosen, no assumption is made regarding the encoding of the identification information sought by the analysis module 5B;
an update module 5C, activated if the analysis module 5B detects that at least one item of identification information in relation to the user U is able to be obtained from the data received by the reception module 5A. The update module 5C is configured, based on the obtained one or more items of identification information where applicable, to update the digital identity IDNUM(U) of the user U. For example, the module 5C adds the identification information detected, where applicable, in the received data to the digital identity IDNUM(U) of the user U if it is not already contained in the digital identity IDNUM(U) or with identification information derived by the analysis module 5B (for example induced by the data analyzed or obtained by correlation, as explained above);
a transmission module 5D configured to relay the received data to their recipient (for example authoritative server 2 for the primary connection, or server X for a secondary connection), in order to make the intervention of the checking entity 5 with regard to the execution of the service S transparent; and
a checking module 5E (optional), configured to check whether the identification information contained in the digital identity IDNUM(U) conform with what is expected for the service S in terms of confidentiality. Various checks may be implemented by the checking module 5E, for example the checking of the conformity of the information contained in the digital identity IDNUM(U) with the general terms and conditions of use of the service S approved by the user U, and/or the relevant constraints imposed by the regulations in force (for example GDPR regulation in the European Union), or else declarations made by the providers of the service S and services ancillary to the service S, provided via the secondary connections, etc. The checking module 5E is advantageously configured to report, for example to the control entity 4, if it detects non-conformity.

The functions of the modules 5A to 5E of each checking entity 5 involved in the DYOS procedure are described in more detail later on with reference to the steps of the checking method according to the invention.

When the computer 7 is or hosts a coordinating entity 6 in accordance with the invention, the read-only memory 10 of the computer 7 comprises a recording of a computer program PROG6 comprising instructions defining the main steps of a configuration method according to the invention.

This program PROG6 defines functional modules of the coordinating entity 6 for coordinating the service S that rely on or control the abovementioned hardware elements 8 to 12 of the computer 7. These modules comprise, in particular, in the embodiment described here:
a communication module 6A enabling it to interface with the control entity 4 according to the invention; and
a configuration module 6B, activated upon receipt of a request from the control entity 4 received by the communication module 6A, and programmed to configure the service S and more particularly the service infrastructure supporting the service S and/or the client equipment 3 so that the data eligible for the DYOS procedure and conveyed on the primary connection (C1) and on the one or more secondary connections (C2), (C2′), etc. established on the fringes of the primary connection (C1) pass through the one or more checking entities 5 selected by the control entity 4 to analyze these data. In order to include such a checking entity 5 in the path of the data transmitted by the user U, the configuration module 6B may proceed in various ways. For example, it may trigger modification of a domain name resolution mechanism (DNS mechanism) so as to include therein reachability information (for example IP address) in relation to the checking entity 5 in question. It may also activate (in the network) a service function chaining (or SFC) mechanism invoking the checking entity 5 in question in the path of the data exchanged when the user U accesses the service S. It may also redirect the data relating to the connections in question to the checking entity 5 or activate a routing mechanism at the source (that is to say from the client equipment 3) to the checking entity 5 (for example, the client equipment 3 is configured by the configuration module 6B to include the one or more checking entities 5 among the intermediate entities passed through by the messages that it sends). These mechanisms may be used as an alternative or in addition.

The functions of the modules 6A and 6B of the coordinating entity 6 for coordinating the service S are described in more detail later on with reference to the steps of the configuration method according to the invention.

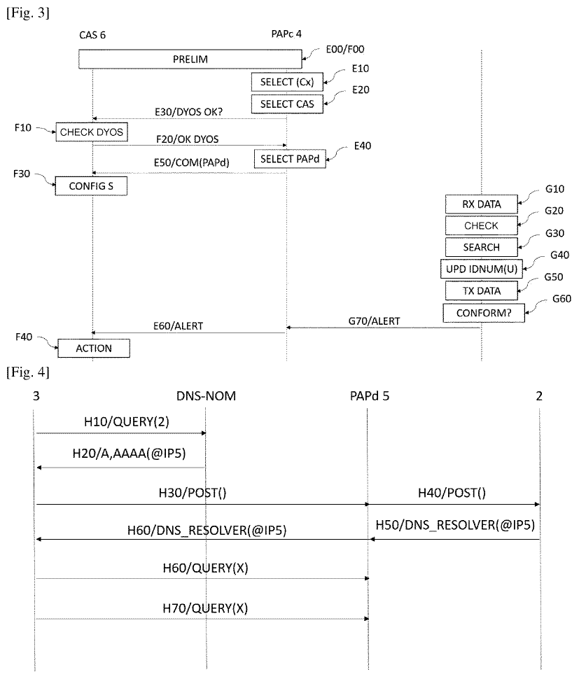

A description will now be given, with reference to FIG. 3, of the DYOS procedure (service) as implemented by the checking system 1 of FIG. 1, in one particular embodiment. This procedure calls upon each entity of the checking system 1, and more particularly triggers the execution of a control method according to the invention (steps E00 to E60) by the control entity 4, of a checking method according to the invention (steps G10 to G70) by each checking entity 5 selected by the control entity 4, and of a configuration method according to the invention (steps F10 to F40) by the coordinating entity 6.

In the embodiment described here, it will be assumed that, during a preliminary phase of activating the DYOS service (step E00/F00), an agreement was put in place between the DYOS service provider, which manages in particular the control entity 4 and the checking entities 5, and the provider SP of the service S. This agreement may be static or put in place using a known mechanism such as CPNP.

As a result of this agreement, the provider SP of the service S maintains a table or, equivalently, a database (referenced by 14 in FIG. 1) in the service realm SR listing the control entities authorized to implement the DYOS procedure for the service S. In the example envisaged here, the table 14 lists, for the service S, the control entity 4 (PAPc 4) of the checking system 1. It is accessible to the coordinating entity 6 of the checking system 1 (or to the coordinating entities 6 if there are several thereof).

In addition, on the DYOS service provider side, the one or more control entities authorized to implement the DYOS procedure maintain a table or, equivalently, a database (referenced by 15 in FIG. 1) listing the one or more coordinating entities with which to interface for each service to be audited. In the example of the service S envisaged here, it will be assumed that the table 15 lists, for the service S, the coordinating entity 6 (CAS 6) of the checking system 1 and that this table 15 is accessible to the control entity 4 responsible for implementing the DYOS procedure for the service S.

The table 15 also contains various information describing the one or more coordinating entities for coordinating the service S, such as in particular one or more items of reachability information (for example IP addresses), one or more domain names to which the one or more coordinating entities are attached, one or more transport protocols supported by the one or more coordinating entities (for example TCP (Transmission Control Protocol), TLS, QUIC, DTLS (Datagram TLS), etc.), one or more protocols of the application layer of the OSI model supported by the one or more coordinating entities (for example HTTP, etc.), etc. The purpose of this information is to enable the control entity 4 to guarantee that the DYOS procedure is executed under the conditions of provision of the service S.

Following this preliminary phase, the control entity 4 designated to implement the DYOS procedure selects the connections (Cx) to be audited involved in the provision of the service S to the user U via their user equipment 3 (step E10).

This selection may be carried out randomly or in a targeted manner, depending in particular on the access network used to access the service (for example on the number of the autonomous system to which the access network belongs), the geographical area in which the user equipment U is located, etc. It may be programmed or triggered by an explicit request from the administrator of the control entity (for example DYOS service provider), or an external event such as for example the notification of a change in the general terms and conditions of use of the service S.

It will be assumed here that, in step E10, the primary connection (C1) and all of the secondary connections (C2), (C2′), etc. established on the fringes of the primary connection (C1) when the user U accesses the service S via their user equipment 3 are selected by the control entity 4 to undergo the DYOS procedure.

As a variant, only some of the connections established when accessing the service S may be selected in this step E10.

The control entity 4 then determines the one or more coordinating entities with which to interface to implement the DYOS procedure in view of the selected connections (step E20). To this end, the control entity 4 here consults the table 15 and the information characterizing the available coordinating entities for coordinating the service S that are listed in this database, on the basis of the characteristics of the connections to be audited (for example transport protocol, application layer protocol, etc.). It will be assumed here that, at the end of step E20, the control entity 4 selects the coordinating entity 6 for coordinating the service S.

The control entity 4 then sends, to the coordinating entity 6 for coordinating the service S, using the reachability information and the other information recorded in the table 15 (for example transport protocol, application layer protocol, etc.), a connection request REQ aimed at implementing the DYOS procedure for the connections selected in step E10 (step E30).

The coordinating entity 6 receives the connection request REQ from the control entity 4 via its communication module 6A and processes it (step F10). More particularly, during this processing, the communication module 6A checks, in the table 14, whether the control entity 4 is authorized to implement the DYOS procedure for the service S. The control entity 4 may also be authenticated according to conditions provided, where applicable, in the preliminary phase E00/F00 (for example using certificates exchanged during this preliminary phase or other known mechanisms such as PSK (Pre-Shared Keys)). If the authorization and/or authentication of the control entity 4 fails, the connection request REQ from the control entity 4 is rejected by the coordinating entity 6.

In the example envisaged here, as mentioned earlier, the control entity 4 is listed in the table 14 as being authorized to implement the DYOS procedure for the service S. The coordinating entity 6 therefore accepts the request REQ made by the control entity 4 to proceed, in accordance with the DYOS procedure, with the analysis of the data conveyed when the user equipment 3 accesses the service S (step F20). It may also, when accepting the request REQ, provide the control entity 4 with one or more constraints of the service S to be taken into account for the execution of the DYOS procedure. Such a constraint is for example a maximum authorized detour time, a geographical area in which the checking entities involved in the DYOS procedure must be deployed, the number of the autonomous system in which the checking entities involved in the DYOS procedure must be located, etc. It should be noted that the provision of these one or more service constraints when the request is accepted is optional. As a variant, these one or more service constraints may be exchanged with the provider of the service S in the preliminary phase E00/F00 of activating the DYOS service.

The coordinating entity 6 accepting the implementation of the DYOS procedure triggers, on the control entity 4, the selection of one or more checking entities 5 to carry out the DYOS procedure, and more particularly to analyze the data exchanged on the connections selected in step E10 (step E40).

This selection is carried out by the selection module 4A of the control entity 4 taking into account the one or more service constraints transmitted by the coordinating entity 6 in step F20 or preconfigured in the preliminary activation phase E00/F00. It will be assumed here, for the sake of simplification, that a single checking entity 5 is selected to process the data conveyed on the primary connection (C1) and on the secondary connections (C2), (C2′), etc.

However, this assumption is not limiting per se, and multiple checking entities 5 checking the service constraints of the service S may be selected, such as for example one separate checking entity per connection to be audited. In addition, multiple checking entities may be deployed at various locations on the one or more networks passed through by the connections to be audited (for example as close as possible to the user equipment 3 or certain networks, close to the authoritative server 2, etc.).

Following the selection of the checking entity 5 by the selection module 4A, the control entity 4 communicates, in a message addressed to the coordinating entity 6, at least one item of reachability information in relation to this checking entity 5, such as its IP address and a corresponding domain name (for example “example.com”) (step E50). This domain name may advantageously be used for authentication purposes, in particular to issue security certificates as described below.

The coordinating entity 6 may then, based on this information, delegate (provide) a “subdomain” name (for example “audit.example.com”) and issue a certificate for the selected checking entity 5 (which may be used for example to decrypt the data to be analyzed where applicable, secure its exchanges with the infrastructures involved in the provision of the service S, or else check that the data that reach it for analysis are actually eligible for the DYOS procedure). However, this step is optional.

The receipt of the message from the control entity 4 also triggers the configuration, by the coordinating entity 6, via its configuration module 6B, of the service function chain involved in the provision of the service S to the user equipment 3 so as to include the checking entity 5 selected by the control entity 4 (or, where applicable, the selected checking entities), in the path of the data exchanged when the user equipment 3 accesses the service S and that have to be audited via the DYOS procedure (step F30). As mentioned above, this may be achieved in various ways by the configuration module 6B (which may be required to configure various entities involved directly or indirectly in the provision of the service S, such as for example the authoritative server 2, the nominal DNS server used by the user equipment 3, the user equipment 3, etc.): modifying the domain name resolution (DNS) chain so as to include reachability information (for example IP address) in relation to the checking entity 5, activating a service function chaining SFC mechanism involving the checking entity 5, redirecting the data conveyed by the connections to be audited to the checking entity 5 (for example configuring the nominal DNS server of the user equipment 3 so that it includes the reachability information in relation to the checking entity 5 in its responses to the DNS requests transmitted by the user equipment 3), routing to the source via the checking entity 5, etc.

More precisely, modifying the DNS chain aims to include the checking entity 5 in the DNS chain, so that the checking entity 5 is able to identify the secondary connections (C2), (C2′), etc. established on the fringes of the primary connection (C1) and audit the data transmitted via these secondary connections. To include the checking entity 5 in the DNS chain called upon when invoking the service S, the coordinating entity 6, in one particular embodiment, may communicate the reachability information (for example IP address) in relation to the checking entity 5 to the authoritative server 2 (entity involved in the provision of the service within the meaning of the invention), so that it indicates to the user equipment 3, for example in response to a message to invoke the service S, transmitted by the user equipment 3 (request for access to the service or request sent later on during consumption of the service itself), to send its domain name resolution requests as part of the service S to the entity associated with this reachability information, in other words to the checking entity 5. This indication may be transmitted in a dedicated header of the response message, for example in a header called DNS_RESOLVER defined for the purposes of the invention. In this way, the checking entity 5 is able to receive the secondary connections (C2), (C2′), etc. established on the fringes of the primary connection (C1) in order to be able to analyze the data conveyed on these secondary connections. It should be noted that, if multiple checking entities are designated by the control entity 4, the DNS_RESOLVER header contains the reachability information in relation to each of the designated checking entities, possibly supplemented with an indication concerning the DNS requests to be sent to a particular checking entity.

FIG. 4 illustrates one exemplary embodiment of what has just been described (traffic redirection and modification of the DNS chain) when the HTTP protocol is used and a single checking entity 5 is selected by the control entity 4.

In this example, the user equipment 3 addresses a DNS request, designated QUERY(2), to its nominal DNS server DNS-NOM with a view to accessing the service S provided by the authoritative server 2 (step H10). The nominal DNS server DNS-NOM responds thereto by providing an IP address, denoted @IP5, of the checking entity 5 (step H20).

The user equipment 3 then sends an HTTP POST request for access to the service S to the authoritative server 2 (filled in for example in the SNI (“Server Name Indication”) or ESNI field when the TLS protocol is used to establish connections as part of the service S) using the IP address @IP5 that has been transmitted thereto as destination address (step H30). This makes it possible to ensure that the associated HTTP POST request passes through the checking entity 5, which may then analyze the data conveyed via this connection (including the POST request). This request is then relayed by the checking entity 5 to its original recipient, namely here the authoritative server 2 (step H40).

The authoritative server 2 processes and responds to the access request from the user equipment 3, in a manner known per se. It also inserts, into this response, the DNS_RESOLVER header containing the IP address @IP5 of the checking entity 5 and indicating to the user equipment 3 to send its future DNS requests to the checking entity 5 associated with this IP address @IP5; this response passes through the checking entity 5 (steps H50 and H60).

Upon receipt of this indication, the user equipment 3 addresses its future DNS requests (QUERY(X)) sent as part of the service S to the checking entity 5 (and no longer to its nominal DNS server DNS-NOM), which is thus ensured of being placed in the flow of the secondary connections established by the user equipment 3 as part of this service (steps H70, H80).

As a variant, it is possible to envisage it being another entity that communicates the DNS_RESOLVER header to the user equipment, such as for example the checking entities themselves when they receive data associated with the user equipment 3, following an appropriate configuration of this equipment, for example by the DYOS service provider.

With reference again to FIG. 3, once the service S has been configured by the configuration module 6B of the coordinating entity 6, the checking entity 5 is located on the paths taken by the data associated with the primary and secondary connections of the user equipment 3 targeted by the DYOS procedure. In other words, all of the data transmitted by the user equipment 3 as part of these connections now pass through the checking entity 5.

Upon receipt of a data packet (step G10), the checking entity 5 checks whether the data packet in question actually belongs to a connection that it has to analyze (for example, based on the “source address” field of the packet) (step G20). If this is not the case, the data packet is deleted.

If this is the case, the checking entity 5, via its analysis module 5B, analyzes the data contained in the packet according to the parameterization with which it has been configured for the service S, and searches for identification information among these data or able to be derived from these data (step G30). If necessary, in this step, it may decrypt the data contained in the packet if said data are encrypted. In this analysis step, the analysis module 5B searches, for example, for the identifiers with which it has been configured, or if new data collection platforms are involved, or else provides its machine learning algorithm with the data from the packet to search for and identify persistent identifiers among these data. The analysis of the data contained in the packet carried out by the analysis module 5B of course depends on its parameterization. The module 5B may also, depending on this parameterization, identify identification information induced by the data, or correlate data with one another or with other elements in order to identify such identification information, etc.

It should be noted that, when the DYOS procedure is triggered by a party other than the DYOS service provider, such as for example the user U, then preferably a procedure is implemented to safeguard this parameterization and to ensure that said party is authorized to perform this parameterization. Such a procedure may be as follows: the user U, via their client equipment 3, contacts the control entity 4 and shares with it a unique identifier ID, such as a hash of a certificate exchanged with the control entity 4, or the first x bits of this hash (for example x=16), this hash possibly being computed for example using the SHA-256 (Secure Hash Algorithm) mechanism known per se. The control entity 4 communicates this unique identifier ID to the coordinating entity 6 in step E50 described above, which triggers, in step F30, the configuration of the service function chain involved in the provision of the service S for the client equipment 3 identified by this unique identifier ID. This unique identifier ID is also used by each primary and secondary connection to identify the client equipment 3.

In step G30 of analyzing the data conveyed in the received packet, if the analysis module 5B identifies identification information in relation to the user U (for example specific identifiers of their user equipment 3 or other sensitive data, location, etc. extracted from the data or induced thereby), the update module 5C of the checking entity 5 then updates the digital identity IDNUM(U) on the basis of the detected identification information (step G40). More particularly, in the embodiment described here, it consults the digital identity IDNUM(U) of the user U to determine whether the detected identification information is already present in the digital identity IDNUM(U), and if this is not the case, it adds the new detected identification information to the digital identity IDNUM(U).

The checking entity 5, via its transmission module 5D, then relays the received and analyzed data packet to the entity receiving this packet (authoritative server 2 if it is a packet transmitted on the primary connection (C1) or server X if it is a packet transmitted on a secondary connection (C2), (C2′), etc.) (step G50). This makes it possible to ensure that the intervention of the checking entity 5 is transparent for the service S.

It should be noted that, depending on the mechanism implemented to involve the checking entity 5 in the path of the data of the connections established by the user equipment 3 when accessing the service, it may prove necessary to encapsulate the data using the transmission module 5D, typically when a tunnel is activated between the checking entity 5 and the recipient of the data packet. This encapsulation may be based on various procedures known to those skilled in the art, such as for example, IPsec, TLS, QUIC, GRE (Generic Routing Encapsulation), DTLS, etc.

In the embodiment described here, the checking entity 5 is also responsible, via its checking module 5E, for checking whether the newly detected identification information and/or the digital identity IDNUM(U) do not contain events that should be reported to the DYOS service provider, via the control entity 4.

Such an event is for example:
the discovery, based on the data analyzed by the checking module 5E, of a new data collection platform involved when accessing the service S. The identification of the type of data collection platform thus discovered may be static, for example based on a list maintained and established by the DYOS service provider, or on the contrary dynamic, via the detection of recurring connections to given domain names. If it has an IP address for this new platform, the checking module 5E may interrogate a database (for example WHOIS base) to resolve the identity of the platform associated with this IP address;
a level of exposure of all or some of the identification information in relation to the user U above a given threshold. Such an exposure level may be estimated by the checking module 5E for the user U considering a particular bit encoding associating a certain number of bits with the identification information so as to characterize the contribution thereof to the identification of the user U. Such an approach advantageously makes it possible to measure, in a unified and global manner, the exposure of a user through the detected identification information. It should be noted that, even if the identification information itself does not directly reveal the identity of the user U per se (that is to say is not personally identifiable information (PII)), other information (for example GPS location) conveyed in data packets transmitted by the user equipment 3 of the user U and coupled with this identification information may make it possible to establish unique profiles, and therefore ultimately to trace the user U. Thus, according to this particular encoding, the greater the number of bits needed to characterize the exposure level, the lower the probability of identifying the user. By way of completely non-limiting example, an exposure level coded on 32 bits is better than an exposure level coded on 16 bits;
new identification information in relation to the user U and detected by the checking entity 5 in the data that it has just analyzed;
identification information in relation to the user U transmitted to a third-party entity that does not comply with the general terms and conditions of use approved by the user U, or a confidentiality regulation in force (for example GDPR regulation in the European Union), or else a declaration made by the provider of the service S indicating its policy in terms of identification information collection and any processing operations carried out on the collected identification information (for example storage, sharing), etc.;
etc.

Upon detection of such an event, the checking module 5E sends a report of the event to the DYOS service provider, and more particularly here to the control entity 4.

In addition to the conformity of the identification information detected on the primary connection with the declaration of the service S provider, in the embodiment described here, the checking entity 5, via its checking module 5E, is also configured to examine the identification information conveyed on each secondary connection that it manages (that is to say that it audits) and to determine whether this identification information and the way in which it is processed by the infrastructures collecting this identification information conform with the declarations made by the operators of these infrastructures, in other words conform with the information collection and processing policies advertised by these operators.

To this end, it will be assumed, in the embodiment described here, that these policies are published using a “well-known” URI as described in IETF document RFC 8615, and referred to here for example as “telemetry-claims”. The checking module 5E is then able to retrieve, by sending a request (for example HTTP GET request) to this URI, said policies in question for each service ancillary to the service S invoked in a secondary connection (C2), (C2′), etc., established on the fringes of the primary connection (C1), and thus obtain the list of identification information and the processing operations carried out, where applicable, according to these policies. It will be assumed here that the body of the response message targeting said URI, received by the checking module 5E, comprises an object structured according to a JSON (JavaScript Object Notation) format, identified by a new “media-type” identifier called for example “application/telemetry-claims”, and indicating the data collected and used by the infrastructure of the ancillary service in question, any processing operations applied to the data (for example if these data are recorded), etc. The JSON object may also indicate whether an audit body has already certified these indications and, where applicable, provide the identity of the body in question and a link to the audit report issued by this body. It may be noted that the body in question may be the DYOS service provider itself, in which case the checking entity 5 has direct access to the audit report in the embodiment described here. The audit in question may be an on-site audit (for example on a server X depending on the connection in question) or a DYOS procedure executed beforehand and involving the infrastructure of the ancillary service in question.

The checking module 5E then checks, for each connection for which it is responsible, whether the identification information conveyed on this connection conforms with the identification information and the declared processing operations that it obtained by targeting the “well-known” URIs. If there is no conformity, it reports this to the control entity 4.

It should be noted that the checking module 5E may also correlate the declarations and identification information that it has detected with audits carried out previously, where applicable, and report any deviation from the declarations. It may also, if an audit has already been carried out as part of the DYOS procedure, dynamically modify and/or supplement the corresponding audit report. It may also locally record an alarm for this service.

The control entity 4 relays each report received from the checking entity 5 to the coordinating entity 6 (step E60), so that action may be taken if necessary depending on the reported event (for example informing the user U) (step F40).

As a variant, it is possible to envisage reporting to other entities, such as for example to the user equipment 3, etc.

In the embodiment that has just been described, the checks carried out as part of the audit are implemented by the module 5E of the checking entity 5. In another embodiment, all or some of these checks may be implemented by another entity of the checking system 1, such as for example the control entity 4. Such an embodiment is advantageous in particular when the checking system 1 comprises multiple checking entities 5 supplying the digital identity IDNUM(U) and managed by one and the same control entity 4.

It should be noted that the DYOS procedure that has just been described makes it possible to carry out an audit not only of the primary connection established to access a service, but also of the secondary connections established on the fringes of this primary connection, and to do so at various points of these connections. It may be combined with an on-site audit, carried out for example on the authoritative server providing the service in question. The DYOS procedure proposed by the invention thus allows a global audit of the service S in order to validate or invalidate compliance by this service and by the underlying (ancillary) services called on to access this service with the personal data of a user.

In addition, the DYOS procedure may be implemented recursively. The procedure that has just been described thus also applies to each secondary connection established in addition to (that is to say on the fringes of) the primary connection, for connections established in addition to said secondary connection (subsequently referred to as higher-level connections), then from each higher-level connection established in addition to each secondary connection, etc. To better describe this scenario, the term “N-level connection” hereinafter denotes the primary connection and “N+1-level connections” denotes the secondary connections established in addition to the primary connection, then “N+2-level connections” denotes the secondary connections established in addition to each N+1-level connection, etc. and, more generally, “N+x-level connections” denotes the connections established in addition to the N+(x−1)-level connections. To manage such a scenario, the procedure that has just been described may be applied recursively to a connection of level N+(x−1) (considered to be a primary connection) and to the connections of level N+x established in addition to this connection (considered in the DYOS procedure to be secondary connections of the N+(x−1)-level primary connection). The audit mechanism proposed by the DYOS procedure may thus advantageously be applied to all connections (that is to say all connections from level N to level N+(x−1)). The digital identity of the user taken into account for the audit carried out by the DYOS procedure may then take into account all of the identification information collected on all of the levels in question.

In the embodiment described here, consideration has been given to an architecture of the checking system 1 based on one coordinating entity and on one control entity. However, it is also possible to have multiple coordinating entities and multiple control entities. Moreover, one and the same checking entity may be managed by multiple control entities.

1. A control method for controlling a check carried out on data conveyed in at least one communication network when a first device of a user accesses a service provided by a second device via a primary connection established between the first and the second device, said method being implemented by a control entity and comprising:
triggering, with a coordinating entity, a configuration of the service such that the data conveyed on said primary connection and on at least one secondary connection established on fringes of said primary connection for provision of the service pass through at least one checking entity selected by said control entity to analyze said data; and
notifying said coordinating entity, in response to a determined event being detected in a digital identity of said user conveyed when accessing said service and comprising identification information in relation to the user obtained from said data analyzed by said at least one checking entity.

2. The control method as claimed in claim 1, wherein said triggering conditional upon prior acceptance of said coordinating entity to carry out the analysis of said data.

3. The control method as claimed in claim 1, comprising selecting said at least one checking entity on based on at least one constraint of said service that is predetermined or transmitted by said coordinating entity.

4. The control method as claimed in claim 1, wherein the triggering comprises providing said coordinating entity with reachability information in relation to said at least one checking entity.

5. A processing method, carried out by a checking entity, for processing data conveyed on at least one communication network when a first device of a user accesses a service provided by a second device via a primary connection established between the first and the second device, at least one secondary connection being established on fringes of said primary connection when providing said service, said method comprising:
receiving data conveyed via said primary connection and/or at least one of the at least one secondary connection;
in response to at least one item of identification information in relation to the user being obtained from said received data, on the basis of said at least one obtained item of identification information, updating a digital identity of the user conveyed when accessing said service; and
relaying said data to a recipient of said data.

6. The processing method as claimed in claim 5, comprising analyzing the received data to determine whether the received data convey at least one item of identification information in relation to the user, said analyzing using at least one parameter with which said checking entity has been configured beforehand and/or that the checking entity has acquired via executing a machine learning algorithm.

7. The processing method as claimed in claim 5, furthermore comprising:
obtaining a list of identification information declared as being conveyed when accessing said service and/or one or more processing operations applied to said list of identification information;
checking conformity of the digital identity of the user with said list and/or with said obtained one or more processing operations; and
performing a reporting step in an event of non-conformity.

8. The processing method as claimed in claim 5, comprising reporting, to said control entity, at least one event detected by the checking entity from among:
a new data collection platform involved when accessing said service;
a level of exposure of identification information in relation to the user above a given threshold;
new user identification information detected by said at least one checking entity in said analyzed data;
user identification information transmitted to a third-party entity that does not comply with terms and conditions of use of said service approved by said user.

9. The processing method as claimed in claim 5, comprising sending, to the first device, a header comprising reachability information in relation to said checking entity, said header indicating to said first device that the first device should send domain name resolution requests to said checking entity.

10. A configuration method for configuring a service provided to a first device by a second device via a primary connection established between the first and the second device, said configuration method being implemented by a coordinating entity and comprising:
upon request of a control entity, configuring the service such that data conveyed on said primary connection and on at least one secondary connection established on fringes of said primary connection for provision of the service pass through at least one checking entity selected by said control entity to analyze said data.

11. The configuration method as claimed in claim 10, wherein the configuring is preceded by checking whether said control entity is authorized to trigger analysis of said data by said at least one checking entity.

12. The configuration method as claimed in claim 10, comprising transmitting, to said control entity, at least one constraint of said service to be taken into account to select said at least one checking entity.

13. The configuration method as claimed in claim 10, wherein the configuring comprises triggering:
modification of a domain name resolution mechanism so as to include reachability information in relation to said at least one checking entity; or
activation of a service function chaining mechanism involving said at least one checking entity; or
a routing mechanism at a source; or
redirection of data to said at least one checking entity.

14. The configuration method as claimed in claim 13, wherein the configuring comprises triggering the modification of the domain name resolution mechanism, and wherein triggering the modification of the domain name resolution mechanism comprises, on an entity involved in provision of the service, activating sending, to the first device, a header comprising said reachability information in relation to said at least one checking entity, said header indicating to said first device that the first device should send all or some of the first device's domain name resolution requests to said at least one checking entity.

15. A control entity for controlling a check carried out on data conveyed in at least one communication network when a first device of a user accesses a service provided by a second device via a primary connection established between the first and the second device, the control entity comprising:
at least one processor; and
at least one non-transitory computer readable medium comprising instructions stored thereon which when executed by the at least one processor configure the control entity to:
trigger, with a coordinating entity, a configuration of the service such that data conveyed on the primary connection and on at least one secondary connection established on fringes of the primary connection for the provision of the service pass through at least one checking entity selected by the control entity to analyze the data; and
notify the coordinating entity in response to a determined event being detected in a digital identity of the user conveyed when accessing the service and comprising identification information in relation to the user obtained from the data analyzed by said at least one checking entity.

16. A checking entity for checking data conveyed on at least one communication network when a first device of a user accesses a service provided by a second device via a primary connection established between the first and the second device, at least one secondary connection being established on fringes of said primary connection when providing said service, said checking entity comprising:
at least one processor; and
at least one non-transitory computer readable medium comprising instructions stored thereon which when executed by the at least one processor configure the checking entity to:
receive data conveyed via said primary connection and/or at least one of said at least one secondary connection;
in response to at least one item of identification information in relation to the user being obtained from said data and on the basis of said at least one obtained item of identification information, update a digital identity of the user conveyed when accessing said service; and
relay said received data to the second device.

17. A coordinating entity able to configure a service provided to a first device by a second device via a primary connection established between the first and the second device, said coordinating entity comprising:
at least one processor; and
at least one non-transitory computer readable medium comprising instructions stored thereon which when executed by the at least one processor configure the coordinating entity to:
configure said service upon request of a control entity such that data conveyed on said primary connection and on at least one secondary connection established on fringes of said primary connection for provision of the service pass through at least one checking entity selected by said control entity to analyze said data.

18. (canceled)
